(19) United States
(12) Patent Application Publication
(10) Pub. No.: US 2010/0103565 A1
(43) Pub. Date: Apr. 29, 2010

(54) ST-RAM EMPLOYING HEUSLER ALLOYS

(75) Inventor: Xiaohua Lou, Bloomington, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/258,491

(22) Filed: Oct. 27, 2008

(51) Int. Cl. G11B 5/33

(52) U.S. Cl. 360/324.11; G9B/5.104

(57) ABSTRACT

A memory cell including a free magnetic layer, the magnetization of which is free to rotate under the influence of spin torque; an insulating layer; and a pinned magnetic layer, wherein at least one of the free magnetic layer or the pinned magnetic layer includes a Heusler alloy, and wherein the insulating layer separates the free magnetic layer from the pinned magnetic layer.

### BACKGROUND

New types of memory have demonstrated significant potential to compete with commonly utilized types of memory. For example, non-volatile spin-transfer torque random access memory (referred to herein as “ST-RAM”) has been discussed as a “universal” memory. Techniques, designs and modifications designed to improve currently utilized structures and materials remain an important area of advancement to maximize the advantages of ST-RAM.

### BRIEF SUMMARY

Disclosed herein is a memory cell including a free magnetic layer, the magnetization of which is free to rotate under the influence of spin torque; an insulating layer; and a pinned magnetic layer, wherein at least one of the free magnetic layer or the pinned magnetic layer includes a Heusler alloy, and wherein the insulating layer separates the free magnetic layer from the pinned magnetic layer.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIGS. 1a, 1b and 1c are illustrations of embodiments of memory devices disclosed herein;

FIG. 2 is an illustration of an embodiment of a memory device disclosed herein that includes a pinned magnetic layer made of a Heusler alloy;

FIG. 3 is an illustration of an embodiment of a memory device disclosed herein that includes a free magnetic layer made of a Heusler alloy;

FIG. 4 is an illustration of an embodiment of a memory device disclosed herein that includes a pinned magnetic layer made of a Heusler alloy and a free magnetic layer made of a Heusler alloy;

FIG. 5 is an illustration of an embodiment of a memory device disclosed herein that includes a memory cell and a transistor; and

FIG. 6 is an illustration of an embodiment of an array of memory devices as disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

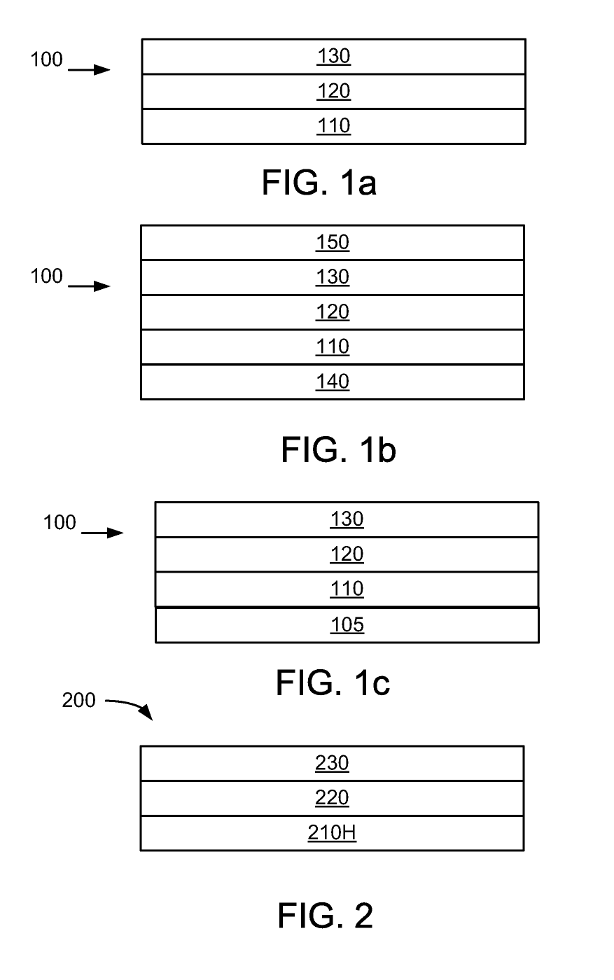

STRAM cells include a magnetic tunnel junction (MTJ). A MTJ generally includes two magnetic electrode layers separated by a thin insulating layer known as a tunnel barrier. An embodiment of a MTJ is depicted in FIG. 1a. The MTJ 100 in FIG. 1a includes a first magnetic layer 110 and a second magnetic layer 130, which are separated by an insulating layer 120. The insulating layer 120 is generally made of an insulating material such as aluminum oxide (Al₂O₃) or magnesium oxide (MgO). FIG. 1b depicts a MTJ 100 in contact with a first electrode layer 140 and a second electrode layer 150. The first electrode layer 140 and the second electrode layer 150 electrically connect the first magnetic layer 110 and the second magnetic layer 130 respectively to a control circuit (not shown) that provides read and write currents through the magnetic layers. The relative orientation of the magnetization vectors of the first magnetic layer 110 and the second magnetic layer 130 can be determined by the resistance across the MTJ 100.

The magnetization layer of one of the magnetic layers, for example the first magnetic layer 110 is generally pinned in a predetermined direction, while the magnetization direction of the other magnetic layer, for example the second magnetic layer 130 is free to rotate under the influence of a spin torque. Pinning of the first magnetic layer 110 may be achieved through, e.g., the use of exchange bias with an antiferromagnetically ordered material such as PtMn, IrMn and others. FIG. 1c illustrates a stack having an antiferromagnetic layer 105 that can be utilized to pin the first magnetic layer 110.

In devices as disclosed herein, at least one of the magnetic layers, the first magnetic layer 110 or the second magnetic layer 130, or both include a Heusler alloy. A Heusler alloy is a ferromagnetic metal alloy based on a Heusler phase. Heusler phases are intermetallics with particular composition and face-centered cubic crystal structures. Heusler alloys are ferromagnetic even though the constituting elements are not a result of the double-exchange mechanism between neighboring magnetic ions. Generally, manganese sits at the body centers in a Heusler alloy.

Normal ferromagnetic materials generally have electrons that are both spin up and spin down. The magnetism in a ferromagnetic material is due to the electrons of one spin that are not cancelled out by the opposing spin. For example, a ferromagnetic material that has more spin up electrons than spin down electrons will have a bulk magnetic field that is due to the spin up electrons. In contrast to normal ferromagnetic materials, Heusler alloys have 100% or almost 100% of the electrons with a single spin direction. For this reason, Heusler alloys are often referred to as “half metals” because they have half the spin of a normal metal.

Because Heusler alloys have 100% or almost 100% of the electrons having the same spin, the spin polarization of Heusler alloys are high. This can provide an advantage to ST-RAM cells utilizing Heusler alloys. ST-RAM cells rely on current to change the magnetization of a cell, i.e. to write to the cell. A cell utilizing a material with a high spin polarization can reduce the current necessary to change the magnetization of the cell. This can lead to memory cells, and memory arrays utilizing such memory cells that require less power.

As stated above, the Heusler alloy layer can include any material that has the characteristics of a Heusler alloy. In an embodiment, a Heusler alloy that includes Manganese (Mn) can be utilized in the Heusler alloy layer. In an embodiment, the Heusler alloy can also include copper (Cu), nickel (Ni), cobalt (Co) or palladium (Pd). In an embodiment, the Heusler alloy can include Cu₂MnAl, Cu₂MnIn, Cu₂MnSn, Ni₂MnAl, Ni₂MnIn, Ni₂MnSn, Ni₂MnSb, Co₂MnAl, Co₂MnSi, Co₂MnGa, Co₂MnGe, Pd₂MnAl, Pd₂MnIn, Pd₂MnSn or Pd₂MnSb. Alloys that are non-stoichiometric alloys can also be utilized herein. A non-stoichiometric alloy is one where the proportions of the elements are not whole numbers. In an embodiment, the Heusler alloy can include Co₂MnGe or non-stoichiometric alloys thereof

Layers containing Heusler alloys can be formed using known methods. An exemplary method includes growing layers of the alloys by coevaporating the elements making up the alloy. Generally, layers containing Heusler alloys can be processed using known methods of processing components utilized in fabrication methods, such as semiconductor fabrication methods.

Generally, layers containing Heusler alloys can have thicknesses that are similar to the thicknesses of ferromagnetic layers generally utilized in ST-RAM cells. In an embodiment, layers containing Heusler alloys can have thicknesses on the nanometer scale. In an embodiment, layers containing Heusler alloys can have thicknesses in the range of about 1 nanometer to about 10 nanometers. In an embodiment, layers containing Heusler alloys can have thicknesses in the range of about 2 nanometers to about 5 nanometers. In an embodiment, layers containing Heusler alloys can have thicknesses of about 2 nanometers.

Devices as disclosed herein can include one magnetic layer that is made of commonly utilized ferromagnetic materials. For example, ferromagnetic alloys such as iron (Fe), cobalt (Co), and nickel (Ni) alloys can be utilized. In an embodiment, the first magnetic layer 110 or the second magnetic layer 130 can be made of alloys such as CoFe, NiFe, CoFeB, NiFeB, FePt, TbCo, TbFe, and TbCoFe for example.

FIG. 2 depicts an exemplary memory cell as disclosed herein. A memory cell 200 includes a pinned Heusler alloy layer 210H, an insulating layer 220 and a free magnetic layer 230. Generally, as seen in FIG. 2, the insulating layer 220 separates the free magnetic layer 230 from the pinned Heusler alloy layer 210H. The insulating layer 220 electrically separates the free magnetic layer 230 from the pinned Heusler alloy layer 210H and can also physically separate the free magnetic layer 230 from the pinned Heusler alloy layer 210H.

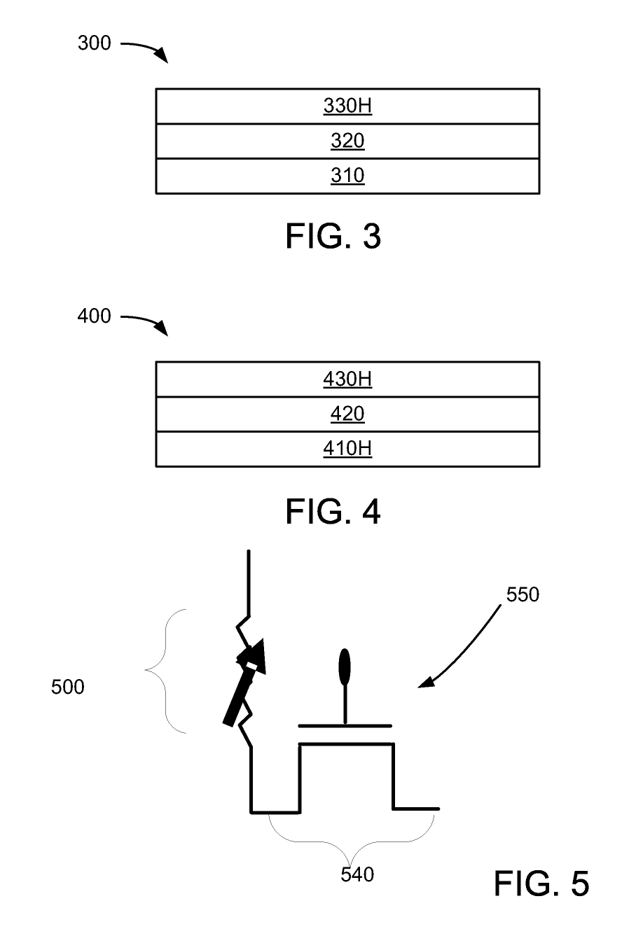

FIG. 3 depicts another exemplary memory cell as disclosed herein. A memory cell 300 includes a pinned magnetic layer 310, an insulating layer 320 and a free Heusler alloy layer 330H. Generally, as seen in FIG. 3, the insulating layer 320 separates the free Heusler alloy layer 330H from the pinned magnetic layer 310. The insulating layer 320 electrically separates the free Heusler alloy layer 330H from the pinned magnetic layer 310 and can also physically separate the free Heusler alloy layer 330H from the pinned magnetic layer 310.

FIG. 4 depicts another exemplary memory cell as disclosed herein. A memory cell 400 includes a pinned Heusler alloy layer 410H, an insulating layer 420 and a free Heusler alloy layer 430H. Generally, as seen in FIG. 4, the insulating layer 420 separates the free Heusler alloy layer 430H from the pinned Heusler alloy layer 410H. The insulating layer 420 electrically separates the free Heusler alloy layer 430H from the pinned Heusler alloy layer 410H and can also physically separate the free Heusler alloy layer 430H from the pinned Heusler alloy layer 410H.

FIG. 5 depicts an exemplary memory device that includes a memory cell as disclosed herein. A memory device 550 includes a memory cell 500 that is electrically connected to a transistor 540. Memory cells as described above may be utilized herein. The transistor 540 generally functions to control the current to the memory cell 500 in order to either read the bit in the memory cell or write a bit to the memory cell. Generally, the orientation of the free magnetic layer (which can be changed by writing to the memory cell) with respect to the pinned magnetic layer (either parallel or anti-parallel) indicates a “1” or a “0”.

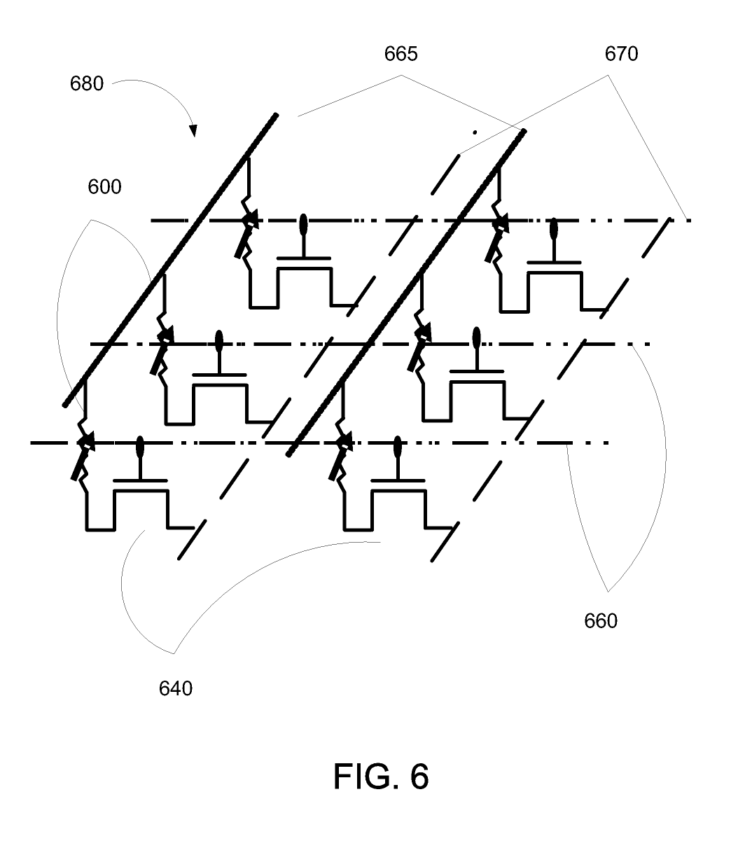

FIG. 6 depicts an exemplary memory array 680 that includes a plurality of memory devices 550 (as exemplified in FIG. 5) as disclosed herein. Generally, a plurality refers to at least two and generally refers to more than two. As seen in FIG. 6, each of the memory devices 550 include a transistor 640 and a memory cell 600. The memory devices 550 can be electrically connected in various manners and configurations by a word line 660, a source line 670, a bit line 665, or a combination thereof. Commonly utilized architectures and methods of electrically connecting memory devices into arrays can be utilized herein.

Memory devices as discussed herein can be utilized in various applications and can generally be utilized in computer systems such as a PC (e.g., a notebook computer; a desktop computer), a server, or it may be a dedicated machine such as cameras, and video or audio playback devices.

Thus, embodiments of ST-RAM EMPLOYING HEUSLER ALLOYS are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A memory cell comprising:
a free magnetic layer, the magnetization of which is free to rotate under the influence of spin torque;
an insulating layer; and
a pinned magnetic layer,
wherein at least one of the free magnetic layer or the pinned magnetic layer comprises a Heusler alloy, and wherein the insulating layer separates the free magnetic layer from the pinned magnetic layer.

2. The memory cell according to claim 1, wherein the free magnetic layer comprises a Heusler alloy.

3. The memory cell according to claim 1, wherein the pinned magnetic layer comprises a Heusler alloy.

4. The memory cell according to claim 1, wherein both the free magnetic layer and the pinned magnetic layer respectively comprise a Heusler alloy.

5. The memory device according to claim 1, wherein the Heusler alloy comprises manganese and at least one of copper, nickel, cobalt, or palladium.

6. The memory device according to claim 5, wherein the Heusler alloy comprises Cu₂MnAl, Cu₂MnIn, Cu₂MnSn, Ni₂MnAl, Ni₂MnIn, Ni₂MnSn, Ni₂MnSb, Co₂MnAl, Co₂MnSi, Co₂MnGa, Co₂MnGe, Pd₂MnAl, Pd₂MnIn, Pd₂MnSn or Pd₂MnSb.

7. The memory device according to claim 6, wherein the Heusler alloy is Co₂MnGe.

8. The memory device according to claim 1, wherein the Heusler alloy layer has a thickness in the range of about 1 nanometer to about 10 nanometers.

9. The memory device according to claim 1 further comprising a first electrode, a second electrode and an antiferromagnetic layer, wherein the antiferromagnetic layer is adjacent to the pinned magnetic layer, the first electrode is adjacent to the free magnetic layer and the second electrode is adjacent to the antiferromagnetic layer.

10. A memory device comprising:
a transistor; and
a memory cell comprising:
a free magnetic layer, the magnetization of which is free to rotate under the influence of spin torque;
an insulating layer; and
a pinned magnetic layer,
wherein at least one of the free magnetic layer or the pinned magnetic layer comprises a material where 100% or almost 100% of its electrons have the same spin, and wherein the insulating layer separates the free magnetic layer from the pinned magnetic layer
wherein the memory cell is electrically connected to the transistor.

11. The memory device according to claim 10, wherein the material where 100% or almost 100% of its electrons have the same spin is a Heusler alloy.

12. The memory device according to claim 10, wherein the free magnetic layer of the memory cell comprises a Heusler alloy.

13. The memory device according to claim 10, wherein the pinned magnetic layer of the memory cell comprises a Heusler alloy.

14. The memory device according to claim 10, wherein both the free magnetic layer and the pinned magnetic layer of the memory cell respectively comprise a Heusler alloy.

15. The memory device according to claim 11, wherein the Heusler alloy comprises Cu₂MnAl, Cu₂MnIn, Cu₂MnSn, Ni₂MnAl, Ni₂MnIn, Ni₂MnSn, Ni₂MnSb, Co₂MnAl, Co₂MnSi, Co₂MnGa, Co₂MnGe, Pd₂MnAl, Pd₂MnIn, Pd₂MnSn or Pd₂MnSb.

16. A memory array comprising:
at least two memory devices, each memory device comprising:
a transistor; and
a memory cell, the memory cell comprising:
a free magnetic layer, the magnetization of which is free to rotate under the influence of spin torque;
an insulating layer; and
a pinned magnetic layer,
wherein at least one of the free magnetic layer or the pinned magnetic layer comprises a Heusler alloy, and wherein the insulating layer separates the free magnetic layer from the pinned magnetic layer,
wherein the memory cell is electrically connected to the transistor; and
at least one bit line, at least one word line and at least one source line, wherein the at least one bit line, at least one word line and at least one source line connect the at least two memory devices.

17. The memory array according to claim 16, wherein the free magnetic layer comprises a Heusler alloy.

18. The memory array according to claim 16, wherein the pinned magnetic layer comprises a Heusler alloy.

19. The memory array according to claim 16, wherein both the free magnetic layer and the pinned magnetic layer respectively comprise a Heusler alloy.

20. The memory array according to claim 16, wherein the Heusler alloy comprises Cu₂MnAl, Cu₂MnIn, Cu₂MnSn, Ni₂MnAl, Ni₂MnIn, Ni₂MnSn, Ni₂MnSb, Co₂MnAl, Co₂MnSi, Co₂MnGa, Co₂MnGe, Pd₂MnAl, Pd₂MnIn, Pd₂MnSn or Pd₂MnSb.
